(19) United States
(12) Patent Application Publication
(10) Pub. No.: US 2026/0208629 A1
(43) Pub. Date: Jul. 23, 2026

(54) REGENERATION UNIT, FUEL CELL CONTROL DEVICE, FUEL CELL STACK, AND METHOD FOR REGENERATING A FUEL CELL STACK

(71) Applicant: Robert Bosch GmbH, Stuttgart (DE)

(72) Inventors: Ulrich Sauter, Karlsruhe (DE); Christophe Gerling, Köngen (DE); Jochen Wessner, Esslingen (DE); Juergen Hackenberg, Sachsenheim (DE); Michael Giuseppe Marino, Linz (AT); Ulrich Berner, Stuttgart (DE)

(21) Appl. No.: 19/140,863

(22) PCT Filed: Dec. 12, 2023
(86) PCT No.: PCT/EP2023/085254

§ 371 Date: Jun. 18, 2025

(30) Foreign Application Priority Data
Dec. 19, 2022 (DE) 10 2022 213 888.0

(51) Int. Cl. B60L 58/30; H01M 8/04223; H01M 8/04313; H01M 8/04746; H01M 8/04791

(52) U.S. Cl. CPC B60L 58/30; H01M 8/04231; H01M 8/04313; H01M 8/04753; H01M 8/04798; B60L 2240/68; B60L 2260/24; H01M 2250/20

(57) ABSTRACT

The invention relates to a regeneration unit (10) for regenerating at least one fuel cell (11) of a motor vehicle,
comprising a detection unit (12) for detecting surroundings data (18) and/or operating data (19) of the at least one fuel cell (11) and/or of the motor vehicle, a monitoring unit (13), wherein the monitoring unit (13) is designed to determine and/or anticipate a coasting mode of the motor vehicle based on the detected surroundings data (18) and/or the detected operating data (19),
a fuel cell interface (14), wherein the fuel cell interface (14) can be connected to a fuel cell monitoring unit (15) of a fuel cell control device (20), and wherein the fuel cell interface (14) is designed to forward the determined and/or anticipated coasting mode from the monitoring unit (13) of the regeneration unit (10) to the fuel cell monitoring unit (15) of the fuel cell control device (20) for carrying out a regeneration process of the at least one fuel cell (11).

### BACKGROUND

The known methods for regenerating a fuel cell stack are usually carried out during a parking phase of a motor vehicle with fuel cells. However, regeneration carried out only during parking phases is too infrequent and leads to increased hydrogen consumption when using the fuel cell or fuel cell stack.

According to the prior art, in coasting mode (required drive power of the vehicle ≤0 kW), the fuel cell stack is operated with a minimum current so that a maximum cell voltage is not exceeded. The power generated by the cell stack is fed to the battery in addition to the recuperation power from the electric machine running in generator mode. However, conversion losses occur when the excess fuel cell power is fed into the battery and this energy is subsequently fed back to the electric motor. If insufficient attention is paid to the electrical potential, operation of the stack at high potentials can lead to increased degradation of the individual fuel cells in the fuel cell stack.

### SUMMARY

The above task is solved by a regeneration unit according to the disclosure, a fuel cell control device according to the disclosure, a fuel cell or fuel cell stack according to the disclosure, and a method for regenerating a fuel cell stack according to the disclosure.

Further features and details of the invention arise from the dependent claims, the description, and the drawings. Features and details described in connection with the regeneration unit according to the invention also apply to the fuel cell monitoring unit according to the invention and/or to the fuel cell stack according to the invention and/or to the method according to the invention and vice versa, so that mutual reference can always be made to the disclosure of the individual aspects of the invention.

According to the invention, a regeneration unit is provided for regenerating at least one fuel cell of a motor vehicle, with a detection unit for detecting surroundings data and/or operating data of the at least one fuel cell and/or of the motor vehicle, with a monitoring unit, wherein the monitoring unit is designed to determine and/or anticipate a coasting mode of the motor vehicle based on the captured surroundings data and/or the captured operating data, with a fuel cell interface, wherein the fuel cell interface can be connected to a fuel cell monitoring unit of a fuel cell control device, and wherein the fuel cell interface is designed to forward the determined and/or anticipated coasting mode from the monitoring unit of the regeneration unit to the fuel cell monitoring unit of the fuel cell control device for carrying out a regeneration process of the at least one fuel cell.

Regeneration is particularly important for the operation of a fuel cell stack, as it prevents or essentially prevents the entire fuel cell stack from losing power. The regeneration unit according to the invention therefore helps to reduce or prevent the performance drop of the fuel cells in a fuel cell stack as far as possible.

In a motor vehicle, coasting mode refers to the driving state in which the engine is towed by the vehicle, i.e. kept in rotary movement, without the traction being disconnected. This means that the drive power required to operate the vehicle is temporarily zero or negative. In some electric vehicles, and particularly in hybrid vehicles, the energy released during coasting mode is used to charge the high-voltage battery.

A coasting mode within the meaning of the invention is, for example, driving downhill, rolling to a stop, coasting, or stopping at a traffic light.

Within the scope of the invention, it may be advantageous for the detection unit to be designed to capture the surroundings data from a navigation device of the motor vehicle via a navigation interface of the regeneration unit, wherein the surroundings data are the current route and/or topography and/or real-time traffic data and/or real-time traffic light data.

The surroundings data captured is real-time data on the respective environmental conditions. The monitoring unit is then able to determine, depending on the data captured by the detection unit, e.g. the route entered in the navigation system and the stored topography, when a downhill descent or a roll to a stop will occur, i.e. when coasting mode is active. Furthermore, traffic lights can be stored which can be approached by a motor vehicle with a fuel cell stack and/or whose real-time data can be accessed by the detection unit in order to obtain their traffic light sequence and incorporate it. At this point, the monitoring unit anticipates coasting mode on the basis of the captured surroundings data.

The captured surroundings data serve as a basis for determining the coasting mode. The coasting mode can be determined or calculated in advance using the surroundings data. The captured surroundings data are determined by the monitoring unit for determining the coasting mode in order to carry out regeneration.

Within the scope of the invention, it is conceivable that the detection unit is designed to detect the operating data from a fuel cell monitoring unit via the fuel cell interface.

Operating data is understood to mean a power request or whether or not a power request is present. The detection unit can receive information about the operating data of a fuel cell stack at intervals from the fuel cell monitoring unit or detect this via the fuel cell interface. The coasting mode is determined when the drive power for driving the electric machine is zero or negative for at least 10 seconds, preferably at least 30 seconds, and preferably at least 60 seconds.

Capturing the operating data provides information on whether coasting mode is active or not, i.e. whether a power request is currently present or not.

Based on the captured operating data, the monitoring unit can now determine the coasting mode. This data is essentially based on real-time operating data from the fuel cell stack.

The above task is also solved by a fuel cell control device according to the invention with a fuel cell monitoring unit and a regeneration unit as described above, wherein the fuel cell monitoring unit and the regeneration unit are connected to each other so as to exchange data, and wherein the fuel cell monitoring unit is designed to perform a regeneration process of at least one fuel cell by means of the regeneration unit on the basis of the determined and/or anticipated coasting mode of the motor vehicle.

In order to keep the performance drop of a fuel cell stack as low as possible, it is advantageous to initiate and carry out regeneration of the fuel cell stack. The fuel cell control device according to the invention therefore helps to reduce or prevent the performance drop of the fuel cells of a fuel cell stack as far as possible. The fuel cell control device uses the coasting mode determined and/or anticipated by the regeneration unit.

The regeneration process, also known as the bleed-down process, is understood here to mean that the supply of media to the fuel cells of the fuel stack is stopped or essentially stopped. This regeneration process, i.e., the interruption of the media supply, prevents high potentials on the cathode at lower load requirements. Furthermore, regeneration of the cathode by means of reducing conditions with simultaneous low hydrogen consumption is possible frequently and can be planned.

The connection for exchanging data between the fuel cell monitoring unit and the regeneration unit can be a wired or wireless connection for data transmission. A wireless connection is primarily understood to mean a radio connection.

According to the invention, it is conceivable that the fuel cell monitoring unit can be connected to the at least one fuel cell and/or a fuel cell stack with a plurality of fuel cells and is designed to regulate and/or control valve units of the at least one fuel cell and/or the fuel cell stack.

The fuel cell monitoring unit can control and/or regulate the valve units of the individual fuel cells or the entire fuel cell stack in order to initiate the regeneration process. The closing of the valve units depends on when and how a coasting mode has been detected and/or anticipated. The valve units can be closed completely or step by step. The ability to control the valve units makes it possible to react quickly to short-term events or to prepare the fuel cell for a regeneration process in which the valve units are closed slowly over a longer period of time.

The above task is further solved by a fuel cell according to the invention with a fuel cell control device described above or by a fuel cell stack according to the invention with a plurality of fuel cells, wherein at least one of the fuel cells has a fuel cell control device described above.

Furthermore, it is conceivable that valve units are provided on the fuel cell stack and/or on the at least one fuel cell.

According to the invention, it is conceivable that the valve units are at least one shut-off valve on a cathode side of the at least one fuel cell and/or the fuel cell stack and/or at least one shut-off valve of a hydrogen supply of the at least one fuel cell and/or the fuel cell stack.

The above task is further solved by a method according to the invention for regenerating at least one fuel cell described above or a fuel cell stack described above of a motor vehicle, wherein the method comprises the following steps of:
capturing surroundings data and/or operating data of the at least one fuel cell and/or of the motor vehicle by means of the detection unit of the regeneration unit,
determining and/or anticipating a coasting mode of the motor vehicle by means of the monitoring unit of the regeneration unit based on the captured surroundings data and/or the operating data,
forwarding the coasting mode determined and/or anticipated by the monitoring unit of the regeneration unit to the fuel cell monitoring unit,
performing a regeneration process of the fuel cell stack by the fuel cell monitoring unit.

The method enables optimized regeneration of the fuel cell. Regeneration is particularly important for the operation of a fuel cell stack, as it prevents or essentially prevents the entire fuel cell stack from losing power. The regeneration unit according to the invention therefore helps to reduce or prevent the performance drop of the fuel cells in a fuel cell stack as far as possible.

As already mentioned above, coasting mode means that the drive power required to operate the vehicle is temporarily zero or negative.

The regeneration process involves stopping the supply of media to the fuel cell or fuel cell stack. This prevents high potentials on the cathode at low load requirements. The method for regenerating the fuel cell, in particular the cathode, by means of these reducing conditions is frequently and predictably feasible. An advantage here is that this can be achieved with low hydrogen consumption.

Furthermore, the invention may provide that, during the regeneration process,
the at least one shut-off valve of a cathode side of at least one fuel cell of a plurality of fuel cells and/or of a fuel cell stack is closed, and
a load, in particular a voltage, is applied to at least one fuel cell and/or the fuel cell stack until a cell voltage of less than 0.6 V, preferably less than 0.3 V, and more preferably less than 0.1 V is reached in the at least one fuel cell and/or in the fuel cell stack, and
at least one shut-off valve of a hydrogen supply to at least one fuel cell and/or the fuel cell stack is closed.

This allows the reducing conditions of the regeneration process to be optimized. The shut-off valves on the cathode side and the shut-off valves for the hydrogen supply can be closed sequentially or simultaneously. The respective shut-off valves or valve units in general can be closed by the fuel cell monitoring unit.

With regard to the present invention, it is conceivable that the detection unit captures the surroundings data via the navigation interface from a navigation device in order to anticipate the coasting mode of the motor vehicle, wherein the coasting mode is anticipated as a function of the surroundings data via the current route and/or topography and/or real-time traffic data and/or real-time traffic light data by means of the monitoring unit of the regeneration unit.

The surroundings data captured is real-time data on the respective environmental conditions. The monitoring unit of the regeneration unit determines, based on the data captured by the detection unit, i.e., for example, the route entered in the navigation system and the stored topography, when a downhill descent or a roll to a stop will occur, i.e., when coasting mode is active. Furthermore, traffic lights can be stored which can be approached by a motor vehicle with a fuel cell stack and/or whose real-time data can be accessed by the detection unit in order to obtain their traffic light sequence and incorporate it. At this point, coasting mode is anticipated on the basis of the captured surroundings data by means of the monitoring unit of the regeneration unit.

Within the scope of the invention, it is conceivable the detection unit detects the operating data via the fuel cell interface from a fuel cell monitoring unit in order to determine the coasting mode, wherein the coasting mode is determined when the drive power for driving the electric machine is zero or negative for at least 10 seconds, preferably at least 30 seconds, and more preferably at least 60 seconds.

Operating data is understood to mean a power request or whether or not a power request is present. The detection unit can receive information about the operating data of a fuel cell stack at intervals from the fuel cell monitoring unit or detect this via the fuel cell interface. Coasting mode therefore always occurs when no power is being transmitted to the electric machine or when the electric machine is in generator mode.

Furthermore, it is conceivable that if a high load is applied before coasting mode, if a high load, in particular a voltage, is applied to at least one fuel cell and/or the fuel cell stack before coasting mode, the shut-off valves on the cathode side of at least one fuel cell and/or the fuel cell stack and/or the shut-off valves of the hydrogen supply to at least one fuel cell and/or the fuel cell stack are regulated and/or controlled in such a way that a cathode stoichiometry of less than 1.5, preferably less than 1.3, more preferably 1.2, is present and/or that the cell voltage does not rise above 0.8 V, preferably not above 0.75 V, particularly preferably not above 0.7 V, before the regeneration process is carried out.

Cathode stoichiometry describes the ratio of hydrogen to oxygen or air. Reduced cathode stoichiometry influences the reducing conditions for performing an optimized bleed-down process. A high load prior to coasting mode refers, for example, to an uphill journey prior to a downhill journey.

### BRIEF DESCRIPTION OF THE DRAWINGS

Further advantages, features, and details of the invention follow from the description hereinafter, in which multiple exemplary embodiments of the invention are described in detail with reference to the drawings. In this context, the features mentioned in the claims and in the description can each be essential to the invention individually or in any combination. The invention is illustrated in the following drawings:

FIG. 1 schematic illustration of a regeneration unit, and

FIG. 2 is a schematic illustration of a fuel cell control device, and

FIG. 3 schematic illustration of a fuel cell or a fuel cell stack, and

FIG. 4 schematic illustration of a method for regenerating a fuel cell stack of FIG. 3.

### DETAILED DESCRIPTION

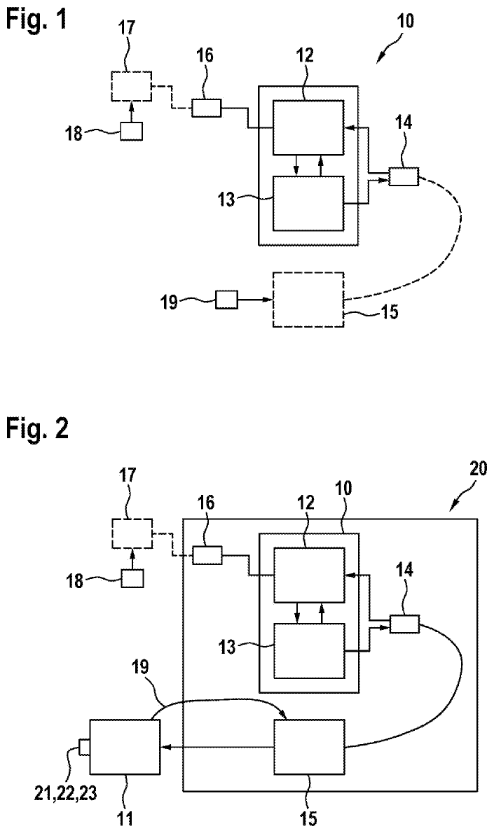

FIG. 1 shows a regeneration unit 10 for regenerating at least one fuel cell 11 of a motor vehicle. The regeneration unit 10 has a detection unit 12 for detecting surroundings data 18 and/or operating data 19 of the at least one fuel cell 11 and/or of the motor vehicle, with a monitoring unit 13, wherein the monitoring unit 13 is designed to determine and/or anticipate a coasting mode of the motor vehicle based on the captured surroundings data 18 and/or the captured operating data 19, and a fuel cell interface 14, wherein the fuel cell interface 14 can be connected to a fuel cell monitoring unit 15 of a fuel cell control device 20, and wherein the fuel cell interface 14 is designed to forward the determined and/or anticipated coasting mode from the monitoring unit 13 of the regeneration unit 10 to the fuel cell monitoring unit 15 of the fuel cell control device 20 for carrying out a regeneration process of the at least one fuel cell 11.

Furthermore, the regeneration unit 10 has a navigation interface 16 for communicating data between the regeneration unit 10 and a navigation device 17. The detection unit 12 of the regeneration unit 10 is designed to capture the surroundings data 18 from a navigation device 17 of the motor vehicle via a navigation interface 16 of the regeneration unit 10, wherein the surroundings data 18 are the current route and/or topography and/or real-time traffic data and/or real-time traffic light data. The detection unit 12 is also designed to capture the operating data 19 from a fuel cell monitoring unit 15 via the fuel cell interface 14.

FIG. 2 shows the fuel cell control device 20 with a fuel cell monitoring unit 15 and a regeneration unit 10 as shown in FIG. 1. The fuel cell monitoring unit 15 and the regeneration unit 10 are connected to each other via a fuel cell interface 14 so as to exchange data, and wherein the fuel cell monitoring unit 15 is designed to perform a regeneration process of the at least one fuel cell 11 on the basis of the determined and/or anticipated coasting mode of the motor vehicle by means of the regeneration unit 10.

The fuel cell monitoring unit 15 can be connected to the at least one fuel cell 11 and/or a fuel cell stack 24 with a plurality of fuel cells 11 and is designed to regulate and/or control valve units 21 of the at least one fuel cell 11 and/or of the fuel cell stack 24.

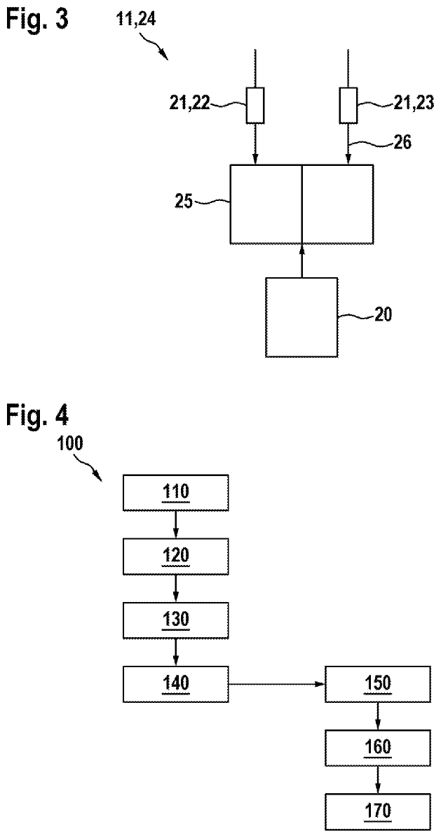

FIG. 3 schematically shows a fuel cell stack 20 with a plurality of fuel cells 11. At least one of the fuel cells 11 has a fuel cell control device 20 as shown in FIG. 2. The valve units 21 are at least one shut-off valve 22 on a cathode side 25 of the fuel cell stack 24 and at least one shut-off valve 23 of a hydrogen supply 26 of the fuel cell stack 24.

The method 100 for regenerating a fuel cell stack, see FIG. 3, of a motor vehicle is shown in FIG. 4, wherein the method comprises the following steps:
capturing 110 surroundings data 18 and/or operating data 19 of the at least one fuel cell 11 and/or of the motor vehicle by means of the detection unit 12 of the regeneration unit 10,
determining 120 and/or anticipating a coasting mode of the motor vehicle by means of the monitoring unit 13 of the regeneration unit 10 based on the captured surroundings data 18 and/or the operating data 19,
forwarding 130 the coasting mode determined and/or anticipated by the monitoring unit 13 of the regeneration unit 10 to the fuel cell monitoring unit 13,
performing 140 a regeneration process of the fuel cell stack 24 by the fuel cell monitoring unit 13.

### During the Regeneration Process

that at least one shut-off valve 22 of a cathode side 25 of the fuel cell stack 24 is closed 150, and
a load, in particular a voltage, is applied 160 to the fuel cell stack 24 until a cell voltage of less than 0.6 V, preferably less than 0.3 V, and more preferably less than 0.1 V is reached in the fuel cell stack 24, and
that at least one shut-off valve 23 of a hydrogen supply 26 at least of the fuel cell stack 24 is closed 170.

The detection unit 12 captures the surroundings data 18 via the navigation interface 16 from a navigation device 17 in order to anticipate coasting mode. The coasting mode is anticipated as a function of the surroundings data 18 via the current route and/or topography and/or real-time traffic data and/or real-time traffic light data by means of the monitoring unit 13 of the regeneration unit 10.

Furthermore, the detection unit 12 captures the operating data 19 via the fuel cell interface 14 from a fuel cell monitoring unit 13 in order to determine the coasting mode. The coasting mode is determined when the drive power for driving an electric machine is zero or negative for at least 10 seconds, preferably at least 30 seconds, and more preferably at least 60 seconds.

If there is a high load, i.e. a voltage, at the fuel cell stack 24 prior to the coasting mode, the shut-off valves 22 on the cathode side 25 of the fuel cell stack 24 and the shut-off valves 23 of the hydrogen supply 26 to the fuel cell stack 24 are regulated and/or controlled in such a way that a cathode stoichiometry of less than 1.5, preferably less than 1.3, more preferably 1.2, is present and/or that the cell voltage does not rise above 0.8 V, preferably not above 0.75 V, particularly preferably not above 0.7 V, before the regeneration process is carried out.

1. A regeneration unit (10) for regenerating at least one fuel cell (11) of a motor vehicle, the regeneration unit comprising:
a detection unit (12) for detecting surroundings data (18) and/or operating data (19) of the at least one fuel cell (11) and/or of the motor vehicle;
a monitoring unit (13), configured to determine and/or anticipate a coasting mode of the motor vehicle based on the detected surroundings data (18) and/or the detected operating data (19); and
a fuel cell interface (14) configured to be connected to a fuel cell monitoring unit (15) of a fuel cell control device (20), wherein the fuel cell interface (14) is configured to forward the determined and/or anticipated coasting mode from the monitoring unit (13) of the regeneration unit (10) to the fuel cell monitoring unit (15) of the fuel cell control device (20) for carrying out a regeneration process of the at least one fuel cell (11).

2. The regeneration unit (10) according to claim 1, wherein the detection unit (12) is configured to detect the surroundings data (18) from a navigation device (17) of the motor vehicle via a navigation interface (16) of the regeneration unit (10), wherein the surroundings data (18) are the current route and/or topography and/or real-time traffic data and/or real-time traffic light data.

3. The regeneration unit (10) according to claim 1, wherein the detection unit (12) is configured to detect the operating data (19) from a fuel cell monitoring unit (15) via the fuel cell interface (14).

4. A fuel cell control device (20) with a fuel cell monitoring unit (15) and a regeneration unit (10) according to claim 1, wherein the fuel cell monitoring unit (15) and the regeneration unit (10) are connected to each other so as to exchange data via a fuel cell interface (14), and wherein the fuel cell monitoring unit (15) is configured to perform a regeneration process of the at least one fuel cell (11) on the basis of the determined and/or anticipated coasting mode of the motor vehicle by means of the regeneration unit (10).

5. The fuel cell control device (20) according to claim 4, wherein the fuel cell monitoring unit (15) can be connected to the at least one fuel cell (11) and/or a fuel cell stack (24) with a plurality of fuel cells (11) and is configured to regulate and/or control valve units (21) of the at least one fuel cell (11) and/or of the fuel cell stack (24).

6. A fuel cell (11) having a fuel cell control device (20) with a fuel cell monitoring unit (15) and a regeneration unit (10) that includes
a detection unit (12) for detecting surroundings data (18) and/or operating data (19) of the at least one fuel cell (11) and/or of the motor vehicle;
a monitoring unit (13) configured to determine and/or anticipate a coasting mode of the motor vehicle based on the detected surroundings data (18) and/or the detected operating data (19); and
a fuel cell interface (14) configured to be connected to a fuel cell monitoring unit (15) of a fuel cell control device (20), wherein the fuel cell interface (14) is configured to forward the determined and/or anticipated coasting mode from the monitoring unit (13) of the regeneration unit (10) to the fuel cell monitoring unit (15) of the fuel cell control device (20) for carrying out a regeneration process of the at least one fuel cell (11),
wherein the fuel cell monitoring unit (15) and the regeneration unit (10) are connected to each other so as to exchange data via a fuel cell interface (14), and wherein the fuel cell monitoring unit (15) is configured to perform a regeneration process of the at least one fuel cell (11) on the basis of the determined and/or anticipated coasting mode of the motor vehicle by means of the regeneration unit (10).

7. The fuel cell (11) according to claim 6, wherein valve units (21) are provided on the fuel cell (11).

8. The fuel cell (11) according to claim 6, wherein the valve units (21) are at least one shut-off valve (22) on a cathode side of the fuel cell (11) and/or at least one shut-off valve (23) of a hydrogen supply of the fuel cell (11).

9. A method (100) for regenerating at least one fuel cell (11) or a fuel cell stack (24) according to claim 6, of a motor vehicle, wherein the method (100) comprises:
capturing (110) surroundings data (18) and/or operating data (19) of the at least one fuel cell (11) and/or of the motor vehicle by means of the detection unit (12) of the regeneration unit (10),
determining (120) and/or anticipating a coasting mode of the motor vehicle by means of the monitoring unit (13) of the regeneration unit (10) based on the captured surroundings data (18) and/or the operating data (19),
forwarding (130) the coasting mode determined and/or anticipated by the monitoring unit (13) of the regeneration unit (10) to the fuel cell monitoring unit (13), and
performing (140) a regeneration process of the fuel cell stack (24) by the fuel cell monitoring unit (13).

10. A method (100) according to claim 9, wherein, during the regeneration process,
the at least one shut-off valve (22) of a cathode side (25) of the at least one fuel cell (11) and/or a fuel cell stack (24) is closed (150), and
a voltage is applied (160) to the at least one fuel cell (11) and/or the fuel cell stack (24) until a cell voltage of less than 0.6 V is reached in the at least one fuel cell (11) and/or in the fuel cell stack (24), and
at least one shut-off valve (23) of a hydrogen supply (26) of the at least one fuel cell (11) and/or of the fuel cell stack (24) is closed (170).

11. The method (100) according to claim 9, wherein the detection unit (12) detects the surroundings data (18) via the navigation interface (16) from a navigation device (17) for anticipating the coasting mode of the motor vehicle, wherein the coasting mode is anticipated as a function of the surroundings data (18) via the current route and/or topography and/or real-time traffic data and/or real-time traffic light data by means of the monitoring unit (13) of the regeneration unit (10).

12. The method (100) according to claim 19, wherein the detection unit (12) detects the operating data (19) via the fuel cell interface (14) from a fuel cell monitoring unit (13) for determining the coasting mode, wherein the coasting mode is determined when the drive power for driving an electric machine is zero or negative for at least 10 seconds.

13. The method (100) according to claim 9, wherein, when a voltage is applied to at least one fuel cell (11) and/or the fuel cell stack (24) before the coasting mode, the shut-off valves (22) of the cathode side (25) of at least one fuel cell (11) and/or the fuel cell stack (24) and/or the shut-off valves (23) of the hydrogen supply (26) of at least one fuel cell (11) and/or the fuel cell stack (24) are regulated and/or controlled in such a way that a cathode stoichiometry of less than 1.5 is present and/or that the cell voltage does not rise above 0.8 V before the regeneration process is carried out (140).
